(19) United States
(12) Patent Application Publication
(10) Pub. No.: US 2024/0375437 A1
(43) Pub. Date: Nov. 14, 2024

(54) RECOVERY BOARD WITH INNER VALLEY

(71) Applicant: Caliber, Inc., Burnsville, MN (US)

(72) Inventors: Ernest J. DeLanghe, Burnsville, MN (US); Kasey L PIPO, Burnsville, MN (US); William BUTTERFIELD, Burnsville, MN (US); Jon LEIKVOLD, Burnsville, MN (US); Steven POTTER, Burnsville, MN (US)

(21) Appl. No.: 18/444,997

(22) Filed: Feb. 19, 2024

Related U.S. Application Data
(60) Provisional application No. 63/485,814, filed on Feb. 17, 2023.

(51) Int. Cl. B60B 39/00

(52) U.S. Cl. CPC B60B 39/00

(57) ABSTRACT

A recovery board for providing traction to a tire or track on a vehicle includes a main body having a leading edge and a trailing edge along a direction of travel wherein a distance between the leading edge and the trailing edge defines a length of the main body. The main body includes a top surface configured to engage the wheel or track of the vehicle having spaced apart rows of exterior gripping features and an interior row of gripping features between the spaced apart rows of exterior gripping features. Upper surfaces of the spaced apart rows of exterior gripping features are at a higher elevation relative to upper surfaces of the interior row of gripping features in a direction transverse to a direction of travel along the length of the main body such that an interior valley is formed between the spaced apart rows of exterior gripping features.

### BACKGROUND

The present disclosure relates to a recovery board configured to provide traction to a tire of a vehicle or a tracked vehicle that is stuck. More particularly, the present disclosure relates to a recovery board having a plurality of internal pillars with a lower profile a plurality of exterior pillars along proximate edges of the recovery board in the direction of travel.

Many people enjoy traveling over terrain with loose soil, such as sand or mud, or over snow packed ground with wheeled or tracked vehicles. Many times, the operator can keep the vehicle moving over the loose soil or snow without getting stuck by maintaining a velocity of the vehicle because the tires or tracks maintain traction in the loose soil or snow.

However, the tires or the track of the vehicle lose traction, the speed of the vehicle slows. At some point, one or more of the tires or tracks will spin out, resulting in the vehicle can becoming stuck.

When the vehicle is stuck, vehicle operators can utilize recovery boards with a gripping surface to provide traction to the tires or tracks that will raise the vehicle from a rut created by the spinning wheels or tracks. However, the grips on typical recovery boards have a substantially same elevation in a direction transverse or substantially orthogonal to a direction of travel, which can provide less than optimal gripping for the tires or tracks. Further, typical recovery boards have convex surfaces proximate the ends, which can cause tires to slip off of or not grip the recovery board because a convex surface of the tire is engaging a convex surface of the recovery board.

There is a need for a recovery board that includes gripping pillars with surfaces at non-uniform elevations, which increases the number of gripping surfaces and, therefore, the probability that the tire or track grips the recovery board. Additionally, there is a need for a non-convex configured end portions of the recovery board to aid in the tire or track maintaining contact with the recovery board as the tire or track attempts to move along the recovery board and become freed from being stuck.

### SUMMARY

An aspect of the present disclosure relates to A recovery board for providing traction to a tire or track on a vehicle. The recovery board includes a main body having a leading edge and a trailing edge along a direction of travel wherein a distance between the leading edge and the trailing edge defines a length of the main body. The main body includes a top surface configured to engage the wheel or track of the vehicle having spaced apart rows of exterior gripping features and an interior row of gripping features between the spaced apart rows of exterior gripping features. Upper surfaces of the spaced apart rows of exterior gripping features are at a higher elevation relative to upper surfaces of the interior row of gripping features in a direction transverse to a direction of travel along the length of the main body such that an interior valley is formed between the spaced apart rows of exterior gripping features.

Another aspect of the present disclosure relates to a recovery board for providing traction to a tire or track on a vehicle. The recovery board includes a main body having a leading edge and a trailing edge along a direction of travel wherein a distance between the leading edge and the trailing edge defines a length of the main body wherein the main body has a substantially concave profile proximate the leading edge and a substantially convex profile extending from the substantially concave profile to the trailing edge. The main body includes a top surface configured to engage the wheel or track of the vehicle having spaced apart rows of exterior gripping features and an interior row of gripping features between the spaced apart rows of exterior gripping features.

### BRIEF DESCRIPTION OF THE DRAWINGS

FIG. 1 is a projection view of a recovery board.

FIG. 2 is a front view of the recovery board.

FIG. 3 is a side view of the recovery board.

FIG. 4 is view of nested recovery boards.

FIG. 5 is a view of recovery boards cinched together with a strap.

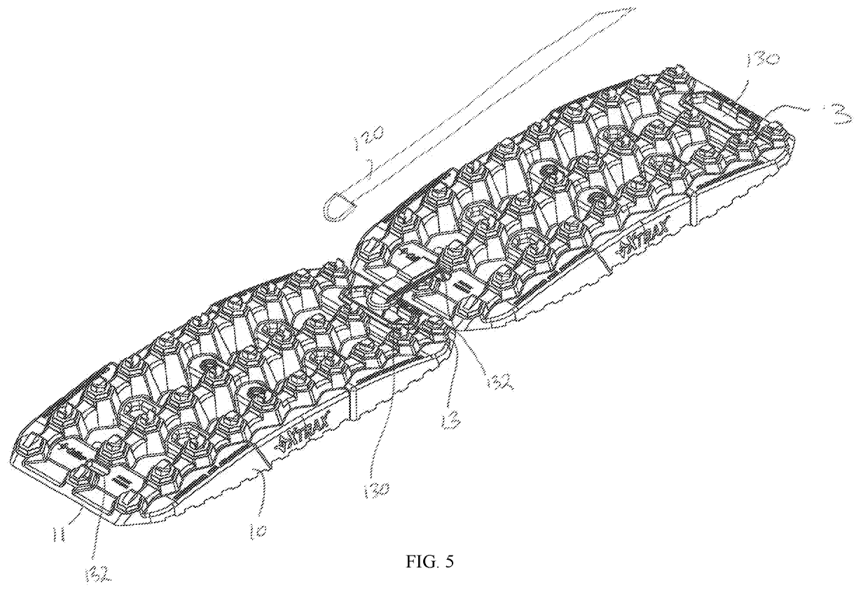

FIG. 6 is a view of a tire engaging a recovery board with a convex profile.

FIG. 7 is a view of the disclosed recovery board engaging a tire.

FIG. 8 is a view of a tire engaging a recovery board with substantially even upper surfaces of gripping features.

FIG. 9 is a view of a tire engaging the disclosed recovery board with the inner valley.

### DETAILED DESCRIPTION

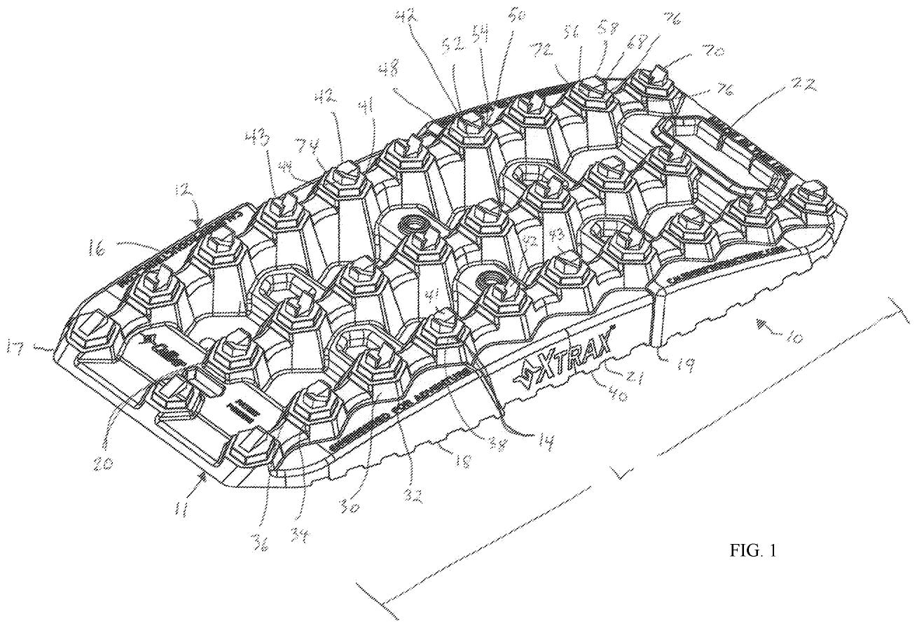

A recovery board configured to provide traction to a tire or track of a vehicle to aid in freeing the vehicle being stuck in loose soil, mud or snow is illustrated at 10 in FIG. 1. The recovery board 10 is configured to provide traction a tire or track that is otherwise stuck or without traction and move the vehicle in the direction of travel.

The recovery board 10 includes a plurality of rows of pillars having surfaces at different elevations transverse to the direction of travel of the vehicle. The plurality of rows of pillars at different elevations increases the number of surfaces or edges that the tire or a lugged track can grip while moving along the recovery board. The recovery board 10 includes a leading end portion 11 with a concave profile along the direction of travel that aid the spinning tire to grip the pillars proximate the leading end portion 11 and travel along a length of the recovery board 10 to the trailing end 13. The leading end portion 11 with the concave profile aids in preventing the tire from sliding off of the recovery board 10 during the engagement process.

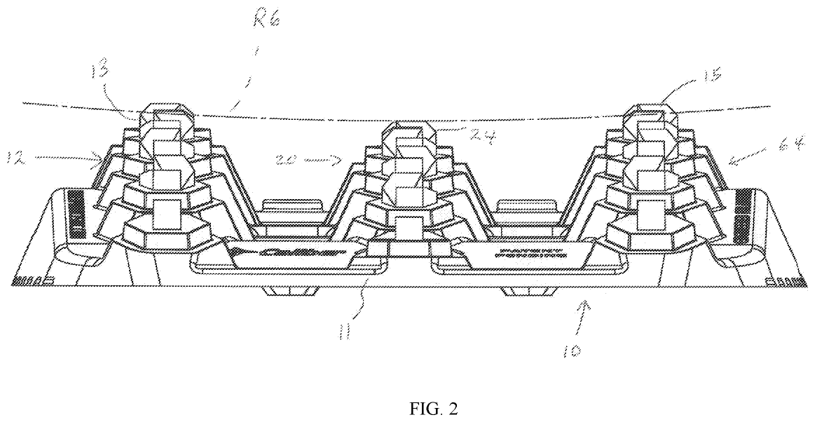

Referring to FIGS. 1 and 2, the recovery board 10 includes outer rows of spaced apart pillars 12 and 14 along a length L proximate opposing side edges 16 and 18 that extend to base surfaces 17 and 19 having cut outs 21 that vary the surface of the recovery board 10 engaging the ground or snow. The recover board also include an interior row of spaced apart pillars 20 proximate a midline 22 that are transversely spaced from the outer rows of spaced apart pillars 12 and 14. Referring to FIG. 2 and as viewed from a direction substantially orthogonal to the midline 22, upper surfaces 24 of the interior row of pillars 20 are lower than upper surfaces 13 and 15 of the outer rows of spaced apart pillars 12 and 14 such that an inner valley 26 or concave contour between the outer pillars 12 and 14 and the interior pillars 20 is formed.

Each of the pillars 12, 14 and 20 have a similar configuration with a hexagonal prism lower portion 30 that has a base 32 that tapers to an upper edge 34. A lower shoulder 36 extends inwardly from the upper edge 34 to a lower end of a middle portion 38 that has a hexagonal prism configuration that leads to an upper shoulder 40.

The pillars 12, 14 and 20 include a first upper portion 42 having a first configuration and a second upper portion 43 having a second configuration that different from the first configuration where both the first and second upper portions 42 and 43 with a hexagonal base 41 that is substantially centrally located on the upper shoulder 40. The first upper portion 42 includes a left inclined plane 44 and a right inclined plane 46 extending from the upper shoulder 40 at a first angle α. Each of the left and right inclined planes 44 and 46 have a base having a thickness a width of a front edge 48 and a back edge 50 and two side edges 52, 54 and 56, 58, respectively. The left inclined plane 44 and the right inclined plane 46 extend from the upper shoulder 40 to an apex or upper edge 60 and 62, respectively where the included planes 44 and 46 lower to a midline where the inclined planes 44 and 46 meet and form a line 64. From the midline to the apex 60 and 62, each inclined plane 44 and 46 includes an edge 66 and 68 that leads to a substantially vertical wall 70 and 72 that provides another surface for the tires to grip. Outer surfaces 74 and 76 of the left and right inclined planes 44 and 46 have the configuration of the side edges 52, 54 and 56, 58, respectively, that also provide additional edges and surfaces for the tire to grip.

The second upper portion 43 includes similar elements as the first upper portion 42. The second upper portion 43 differs for the first upper portion in that an angle β of the left and right inclined planes 44 and 46 is steeper than the angle α of the first configuration which results in the apex 60 and 62 having a sharper edge than illustrated in the first configuration, where the sharper edge is configured to engage a sipe of a tread to provide additional surfaces for engagement with the tire.

The row 14 of exterior pillars and the row of interior pillars 20 includes the same first and second upper portion 42 and 44 configurations. The laterally adjacent pillars of the rows 14 and 20 have the same configuration while the upper portions in the rows alternate between the first upper portion 42 configuration and the second upper portion 44 configuration. However, the row 12 of pillars has the opposite upper portion configuration, where the row of pillars 12 will have the second upper portion 43 relative to the adjacent pillar 20 having the first upper portion 42. Having the different configurations of the upper portions 42 and 43 in a direction transverse to the direction of travel increases the number of different edges and surfaces, which increases the likelihood of the tire gripping the recovery board 10. The hexagonal lower portion 30, the middle portion 38 and the upper portion 42 or 43 which are connected with the lower shoulder 36 and the upper shoulder 40 provide a plurality of surfaces that a tread or sipe of the tread/and/or the side walls of the tire can grip relative to a substantially smooth pillar.

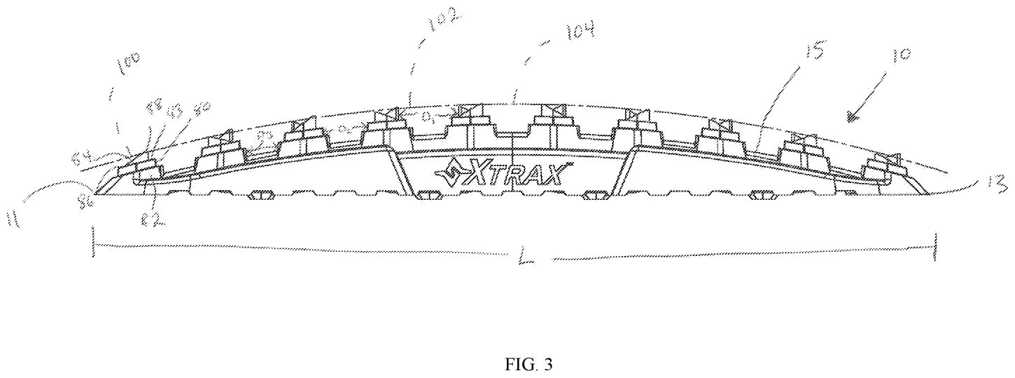

Referring to FIG. 3, the recovery board 10 is directional in nature where the leading end portion 11 includes a substantially concave profile while the trailing end portion 13 includes a substantially convex profile. The concave profile of the leading end portion 11 includes pillars 80 that have a different configuration from the other pillars 12, 14 and 20, where the pillars include a hexagonal prism base 82 that leads to a shoulder 83 from which an inclined plane 84 extends. A lower end 86 of the inclined plane 84 is proximate the leading edge and the raised end 88 is a greater distance from the leading edge relative to the lower end 86. The configuration of the pillars 80 relative to adjacent pillars 12, 14 and 20 in the exterior rows and the interior row define a concave profile that more readily accepts the convex profile of the tire and aid in retaining the spinning tire on the recovery board 10.

Additionally, having a larger lower portion, an intermediate sized middle portion and the upper portions of spaced apart pillars accepts lugs of tracked vehicles with different thickness. The distance D1 between adjacent lower portions accepts a track with a first lug thickness. The distance D2 between the adjacent middle portions accepts a lug of a track with a second lug thickness and the distance D3 between the adjacent upper portions accepts a lug of a track with third lug thickness. As most tracked vehicles, such as snow machines, have one of three lug spacings, the recovery board 10 is configured to work with a vast majority of snow machines.

As viewed from the side, the recovery board has a concave profile 100 proximate the leading end portion 11 which leads to a convex profile 102 that extends from the concave profile 100 through an apex 104 proximate a midpoint 106 along the length L to the trailing end 13. The concave profile 100 proximate the leading end portion 11 aids in the convex tire to grip the recovery board 10 while the convex profile 102 aids in distancing the tire from the soil or snow in which the tire is stuck.

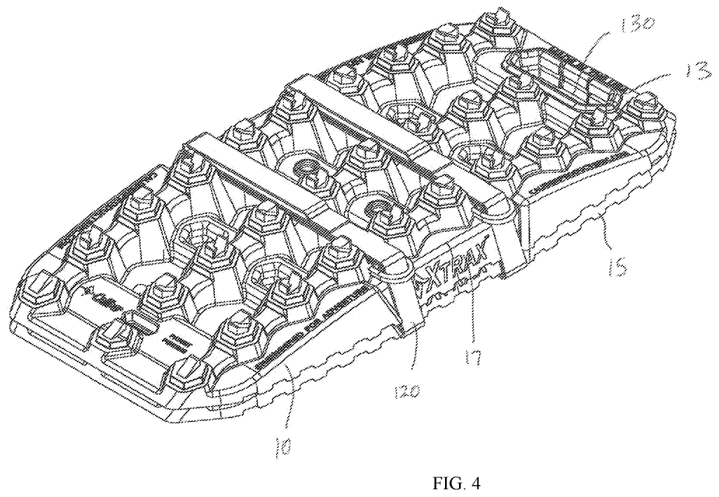

The recovery board 10 is typically molded from a polymeric material having sufficient structural integrity to withstand the weight of a vehicle and also withstand the torque imparted by the rotating tires. The recovery board 10 includes top and bottom surfaces 15 and 17 that allows a plurality of recovery boards 10 to be nested together during storage as illustrated in FIG. 4. The nested recovery boards can be retained together by positioning straps 120 between spaced apart pillars and securing the straps in a looped configuration with a buckle 122.

The recovery board 10 includes an opening 130 proximate the trailing end 13 that is configured to accept the finger of a user such that the recovery board 10 can be easily gripped and maneuvered. The recovery board 10 includes a slot 132 proximate the leading edge 11 that is configured to accept the strap 120. In the event that the tire or track is sufficiently deep to require two or more recovery boards 10 to be linked together, the strap 120 can be positioned through the opening 130 proximate the trailing end 13 and the slot 132 in another recovery board 10 proximate the leading edge 11 such that two or more The straps can also be used to retain or tie two or more recovery boards together to provide a longer length, which may be needed depending upon the depth and length of the loose or slick soil and/or snow.

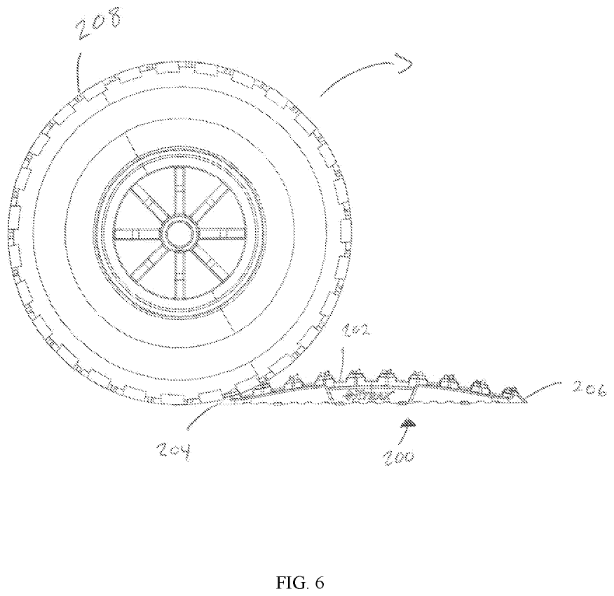

Referring to FIG. 6, a typical recovery board 200 with a convex profile 202 from a leading edge 204 to a trailing edge 206 is illustrated. A tire 208 is illustrated attempting to engage the convex leading edge 204. However, the convex tire 208 has difficultly engaging the convex leading edge 204 and may spin out and not gain traction on the recovery board 200. Additionally, while the convex tire 208 may gain some traction on the recovery board 200, the tire 208 may not establish sufficient traction on the recovery board 200 and may slide off in a direction transverse to the direction of travel as the tire spins.

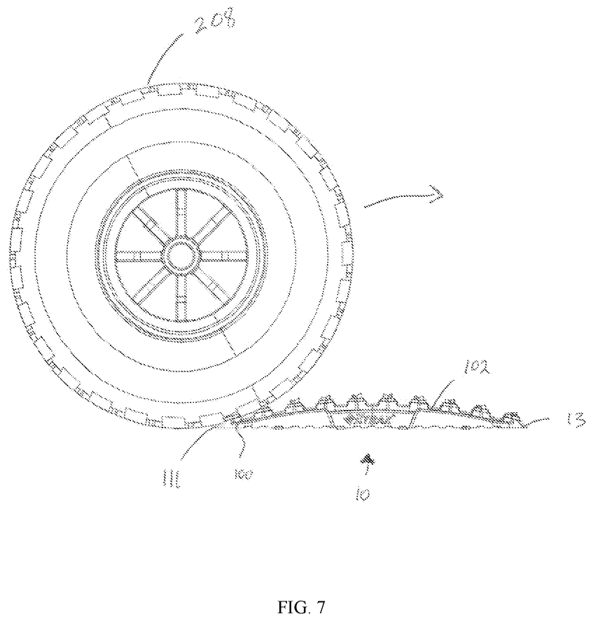

Referring to FIG. 7, the recovery board 10 is illustrated with the concave profile 100 proximate the leading edge 11 and the convex profile 102 extending from the concave profile to the trailing edge 13. A convex tire 208 engages the concave profile 100 such that the tire gains traction on the recovery board. Once on the recovery board 10, the tire 208 climbs the convex profile 102 and travels along the length of the recovery board 10 to disengage the tire 208 from the soil or snow.

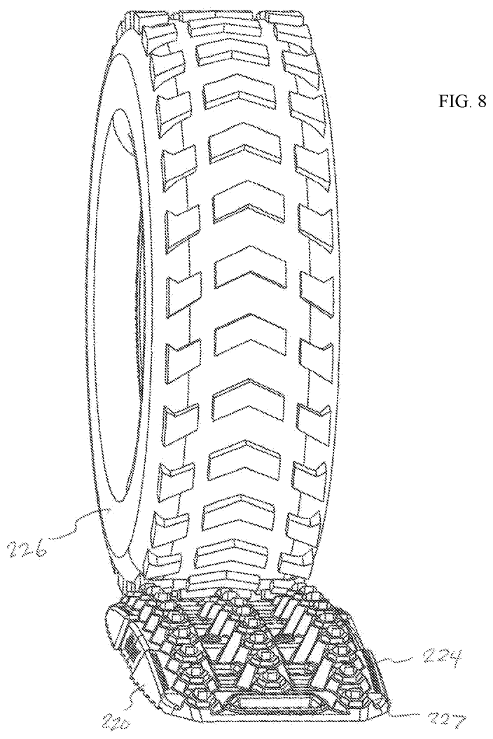

Referring to FIG. 8, a typical recovery board 220 is illustrated where traction features 224 have substantially an even upper surface 222 in direction transverse to the direction of travel. An even upper surfaces 222 on the traction features 224 limits the number of surfaces that the tire 226 can engage and can limit the amount of traction that the tire 226 can gain on the recovery board 220.

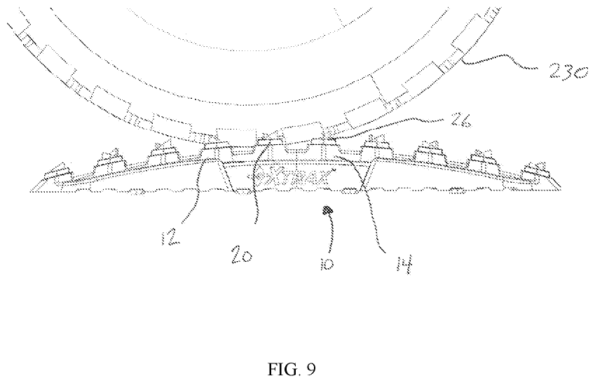

Referring to FIG. 9, a tire 230 is illustrated engaging the recovery board 10 having the rows of exterior pillars 12 and 14 and the lower row of inner pillars 20 that form the inner valley 26. The tire 230 can have a sidewall 232 within the inner valley 26 such that the tire engages a feature of the row of pillars 14 and the upper surfaces of the pillars of the exterior pillars 12 and the inner pillars 20. The inner valley 26 allows more surfaces and edges to be available for the tire to grip, which increases the likelihood of the tire 230 gripping and moving along the length of the recovery board 10.

Although the present invention has been described with reference to preferred embodiments, workers skilled in the art will recognize that changes may be made in form and detail without departing from the spirit and scope of the invention.

The invention claimed is:

1. A recovery board for providing traction to a tire or track on a vehicle, the recovery board comprising:
a main body having a leading edge and a trailing edge along a direction of travel wherein a distance between the leading edge and the trailing edge defines a length of the main body, the main body comprising:
a top surface configured to engage the wheel or track of the vehicle having spaced apart rows of exterior gripping features and an interior row of gripping features between the spaced apart rows of exterior gripping features, wherein upper surfaces of the spaced apart rows of exterior gripping features are at a higher elevation relative to upper surfaces of the interior row of gripping features in a direction transverse to a direction of travel along the length of the main body such that an interior valley is formed between the spaced apart rows of exterior gripping features.

2. The recovery board of claim 1, wherein the main body has a substantially concave profile proximate the leading edge and a substantially convex profile extending from the substantially concave profile to proximate the trailing edge.

3. The recovery board of claim 1, wherein the main body comprises a first slot proximate the trailing edge and a second slot proximate the leading edge.

4. The recovery board of claim 3, and further comprising a strap, wherein the strap is configured to be positioned thought the first and second slots such that when recovery boards are positioned adjacent each other the strap can cinch the adjacent recovery boards together.

5. The recovery board of claim 1, wherein the gripping features located along the length of the main body a distance from the leading edge each comprises:
a bottom polygonal prism;
a middle polygonal prism joined to the bottom polygonal prism with a lower shoulder; and
a top gripping feature, a portion of which comprises a top polygonal prism joined to the middle polygonal prism with an upper shoulder.

6. The recovery board of claim 5, wherein the bottom polygonal prism, the middle prism and the portion of which is a polygonal prism of the top gripping feature each comprises a hexagonal prism.

7. The recovery board of claim 5, wherein adjacent gripping features having the bottom polygonal prism, the middle prism and the portion of which is a polygonal prism have different gaps between the bottom polygonal prisms, the middle prism sand the portions of which is a polygonal prisms such that lugs of different thickness can be positioned between adjacent gripping features to provide traction for the track of the vehicle.

8. The recovery board of claim 2, wherein the gripping features of the exterior gripping features and the interior gripping features proximate the leading edge comprises an inclined ramp oriented such that a lower end is proximate the leading edge and a raised end is a distance from the leading edge.

9. The recovery board of claim 1, wherein the main body comprises a bottom surface having substantially a same configuration as the top surface, such that a plurality of recovery boards can be nested on top of each other.

10. The recovery board of claim 1, wherein the upper surfaces of adjacent gripping features in each of the rows of exterior gripping features are different from each other.

11. The recovery board of claim 1, where the upper surfaces of aligned gripping features of the exterior rows of the gripping features in a direction transverse to the direction of travel are different from each other.

12. The recovery board of claim 1, wherein at least some of the upper surfaces of the spaced apart exterior rows of gripping features and the interior row of gripping features include substantially horizontal edges configured to engage a sipe of a tread of the tire.

13. A recovery board for providing traction to a tire or track on a vehicle, the recovery board comprising:
a main body having a leading edge and a trailing edge along a direction of travel wherein a distance between the leading edge and the trailing edge defines a length of the main body wherein the main body has a substantially concave profile proximate the leading edge and a substantially convex profile extending from the substantially concave profile to the trailing edge, the main body comprising:
a top surface configured to engage the wheel or track of the vehicle having spaced apart rows of exterior gripping features and an interior row of gripping features between the spaced apart rows of exterior gripping features.

14. The recovery board of claim 13, wherein upper surfaces of the spaced apart rows of exterior gripping features are at a higher elevation relative to upper surfaces of the interior row of gripping features in a direction transverse to a direction of travel along the length of the main body such that substantially concave valley is formed between the spaced apart rows of exterior gripping features in a direction transverse to a direction of travel.

15. The recovery board of claim 13, wherein the main body comprises a first slot proximate the trailing edge and a second slot proximate the leading edge.

16. The recovery board of claim 14, and further comprising a strap, wherein the strap is configured to be positioned thought the first and second slots such that when recovery boards are positioned adjacent each other the strap can cinch the adjacent recovery boards together.

17. The recovery board of claim 13, wherein the gripping features located along the length of the main body a distance from the leading edge each comprises:
a bottom polygonal prism;
a middle polygonal prism joined to the bottom polygonal prism with a lower shoulder; and
a top gripping feature, a portion of which comprises a top polygonal prism joined to the middle polygonal prism with an upper shoulder.

18. The recovery board of claim 16, wherein the bottom polygonal prism, the middle prism and the portion of which is a polygonal prism of the top gripping feature each comprises a hexagonal prism.

19. The recovery board of claim 16, wherein adjacent gripping features having the bottom polygonal prism, the middle prism and the portion of which is a polygonal prism have different gaps between the bottom polygonal prisms, the middle prism sand the portions of which is a polygonal prisms such that lugs of different thickness can be positioned between adjacent gripping features to provide traction for the track of the vehicle.

20. The recovery board of claim 13, wherein the gripping features of the exterior gripping features and the interior gripping features proximate the leading edge comprises an inclined ramp oriented such that a lower end is proximate the leading edge and a raised end is a distance from the leading edge.

21. The recovery board of claim 13, wherein the main body comprises a bottom surface having substantially a same configuration as the top surface, such that a plurality of recovery boards can be nested on top of each other.

22. The recovery board of claim 13, wherein the upper surfaces of adjacent gripping features in each of the rows of exterior gripping features are different from each other.

23. The recovery board of claim 13, where the upper surfaces of aligned gripping features of the exterior rows of the gripping features in a direction transverse to the direction of travel are different from each other.
